(19) United States
(12) Patent Application Publication
(10) Pub. No.: US 2015/0173421 A1
(43) Pub. Date: Jun. 25, 2015

(54) MAIN BODY OF AN ELECTRONIC CIGARETTE AND A SWITCH ASSEMBLY OF THE SAME

(71) Applicant: QIE Co., Ltd., New Taipei City (TW)

(72) Inventor: Chih-Kang Hsieh, New Taipei City (TW)

(21) Appl. No.: 14/306,945

(22) Filed: Jun. 17, 2014

(30) Foreign Application Priority Data
Dec. 23, 2013 (TW) 102224213

(51) Int. Cl. A24F 47/00; H01H 9/20

(52) U.S. Cl. CPC A24F 47/008; H01H 9/20; H01H 2221/052

(57) ABSTRACT

A switch assembly of a main body of an electronic cigarette has a casing, a control unit, a switch element and a locking element. The switch element has an actuating element. The locking element is rotatable relative to the casing, and has a stop segment. A position of the stop segment may be adjusted by rotating the locking element. When the locking element is rotated to make the stop segment abut the switch element, the switch element cannot be pressed to actuate the control unit. No matter at what angle the main body is disposed, the locking element does not tend to be rotated and unlocked by its weight as the locking element is not screwed to the casing and is rotated at the same position. Therefore, the locking element is effectively kept locked to prevent the electronic cigarette from being switched on accidentally.

### CROSS-REFERENCE TO RELATED APPLICATIONS

This application is based upon and claims priority under 35 U.S.C. 119 from Taiwan Patent Application No. 102224213 filed on Dec. 23, 2013, which is hereby specifically incorporated herein by this reference thereto.

### BACKGROUND OF THE INVENTION

1. Field of the Invention

The present invention relates to a main body of an electronic cigarette and a switch assembly of the main body of the electronic cigarette.

2. Description of the Prior Arts

A conventional electronic cigarette comprises a main body and an atomizer. With reference to FIG. 13, the conventional main body comprises a bottom cover 91, a switch assembly 92, a short battery sleeve 93 and an atomizer connector 94 connected to one another in sequence. A battery 95 is mounted in the short battery sleeve 93, and is preferably a lithium battery. Two ends of the lithium battery 95 respectively abut the switch assembly 92 and the atomizer connector 94. The short battery sleeve 93 is an electronic conductor, such that the switch assembly 92, the lithium battery 95, the atomizer connector 94 and the short battery sleeve 93 form a circuit. The atomizer connector 94 is used for connecting to the atomizer. The switch assembly 92 has a pressing-pattern switch 921. A user presses the switch 921 to switch on the conventional main body of the electronic cigarette. The electric power stored in the lithium battery 95 is transmitted to the atomizer connector 94, and then is transmitted to the atomizer. The atomizer is switched on and produces smoke to simulate physical cigarette smoking for the user. The main body of the electronic cigarette is for lithium battery 95 with relative short length, such as 18350 lithium battery. With reference to FIG. 14, a long batter sleeve 96 may be mounted between the switch assembly 92 and the short battery sleeve 93 to accommodate a lithium battery 95 with relative long length, such as 18650 lithium battery.

However, the conventional main body of the electronic cigarette has the following shortcomings.

First, the switch 921 of the switch assembly 92 protrudes transversely, such that the switch 921 may be easily pressed accidentally and switched on. Besides, the transversely protruding switch 921 is aesthetically unappealing.

Second, the switch assembly 92 has a locking element 922 to prevent the switch 921 from being pressed accidentally. The locking element 922 is a nut. When the locking element 922 is rotated to be moved transversely outward to abut the switch 921, the switch 921 cannot be pressed, thereby locking the switch 921 and preventing the switch 921 from being switched on accidentally. However, when the main body of the electronic cigarette is disposed at an angle such that the locking element 922 is disposed upward, the locking element 922 tends to be moved downward by its weight. At this time, any slight external force may make the locking element 922 move downward and leave the switch 921. Then the switch 921 of the main body of the electronic cigarette is easily unlocked, and is still easily to be pressed and switched on accidentally.

Third, the switch assembly 92 is connected electrically to another object via only one end thereof. Thus, the switch assembly 92 can only be disposed in one end of the main body, which means the switch assembly 92 is disposed between the bottom cover 91 and the short battery sleeve 93 (or long battery sleeve 96). Therefore, the position of the switch 921 cannot be adjusted to fit various habits of switching on the switch 921 of different users. In addition, the conventional lithium battery 95 protrudes into the switch assembly 92. Thus, if both ends of the switch assembly 92 can be connected electrically to other objects, the switch assembly 92 must be longer to allow the ends thereof to accommodate the lithium battery 95. But it is not convenient to carry the bigger electronic cigarette.

To overcome the shortcomings, the present invention provides a main body of an electronic cigarette and a switch assembly of the same to mitigate or obviate the aforementioned problems.

### SUMMARY OF THE INVENTION

The main objective of the present invention is to provide a switch assembly of a main body of an electronic cigarette that can be effectively kept locked to avoid being accidentally switched on.

The switch assembly of a main body of an electronic cigarette has a casing, a control unit, a switch element and a locking element. The casing has a switch hole. The control unit is mounted in the casing and has at least one electrical connecting segment. The switch element is transversely moveably mounted in the switch hole of the casing, and has an actuating element being an electric conductor and selectively actuating the control unit. The locking element is rotatable relative to the casing along an axis of the casing, and has a stop segment selectively abutting the switch element.

A position of the stop segment may be adjusted by rotating the locking element. Thus, when the locking element is rotated to make the stop segment abut the switch element, the switch element cannot be moved transversely inward, such that the control unit cannot actuate the main body of the electronic cigarette. No matter at what angle the main body of the electronic cigarette is disposed, the locking element does not tend to be rotated and unlocked by its weight as the locking element is not screwed to the casing and is rotated at the same position. Therefore, the locking element is effectively kept locked to prevent the electronic cigarette from being switched on accidentally.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a main body of an electronic cigarette in accordance with the present invention;

FIG. 2 is an exploded perspective view of the main body of an electronic cigarette in FIG. 1;

FIG. 3 is another exploded perspective view of the main body of an electronic cigarette in FIG. 1;

FIG. 4 is an exploded perspective view of a switch assembly of the main body of an electronic cigarette in FIG. 1;

FIG. 5 is another exploded perspective view of the switch assembly of the main body of an electronic cigarette in FIG. 1;

FIG. 6 is a front view in partial section of the switch assembly of the main body of an electronic cigarette in FIG. 1;

FIG. 7 is a side view in partial section of the switch assembly of the main body of an electronic cigarette in FIG. 1, showing the switch assembly unlocked;

FIG. 8 is a side view in partial section of the switch assembly of the main body of an electronic cigarette in FIG. 1, showing the switch assembly locked;

FIG. 9 is an operational view of the main body of an electronic cigarette in FIG. 1, showing the main body installed with a long lithium battery;

FIG. 10 is an operational view of the main body of an electronic cigarette in FIG. 1, showing the main body installed with a short lithium battery;

FIG. 11 is an operational view of the main body of an electronic cigarette in FIG. 1, showing the switch assembly mounted in a reverse direction relative to FIG. 9;

FIG. 12 is an operational view of the main body of an electronic cigarette in FIG. 1, showing a position of the switch assembly adjusted;

FIG. 13 is an operational view of a conventional main body of an electronic cigarette in accordance with the prior art, showing the main body installed with a short lithium battery; and

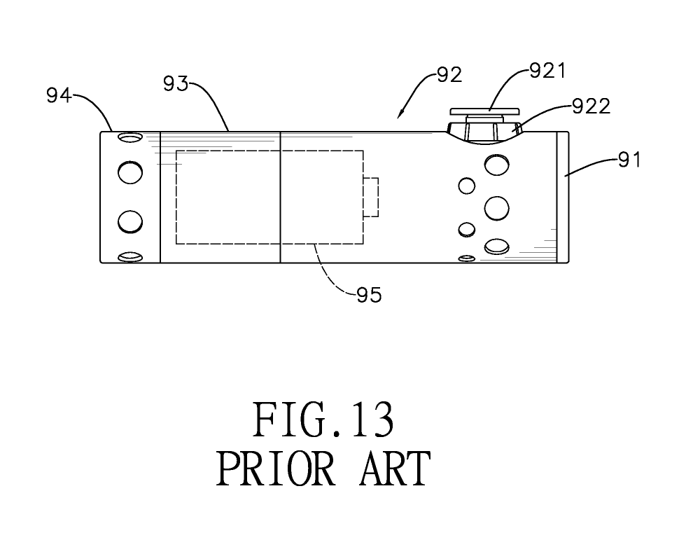

FIG. 14 is an operational view of the conventional main body of an electronic cigarette in FIG. 13, showing the main body installed with a long lithium battery.

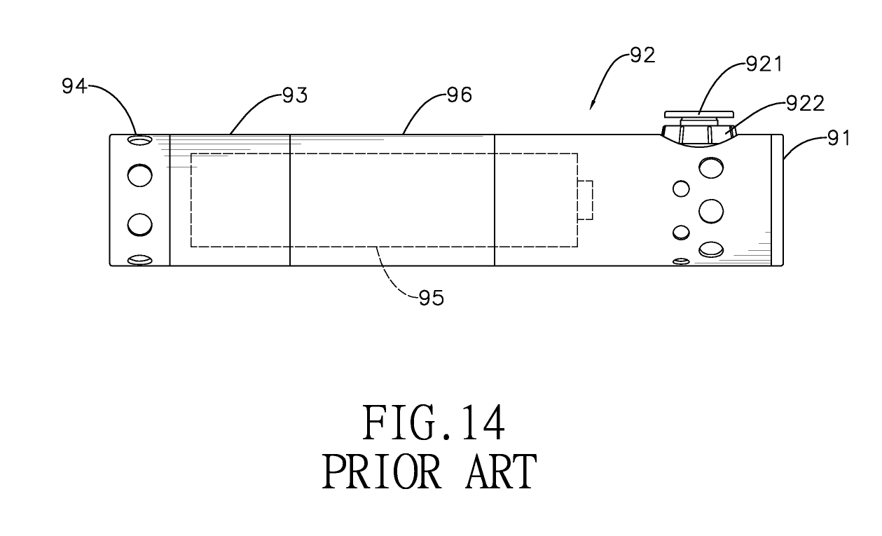

### DETAILED DESCRIPTION OF THE PREFERRED EMBODIMENTS

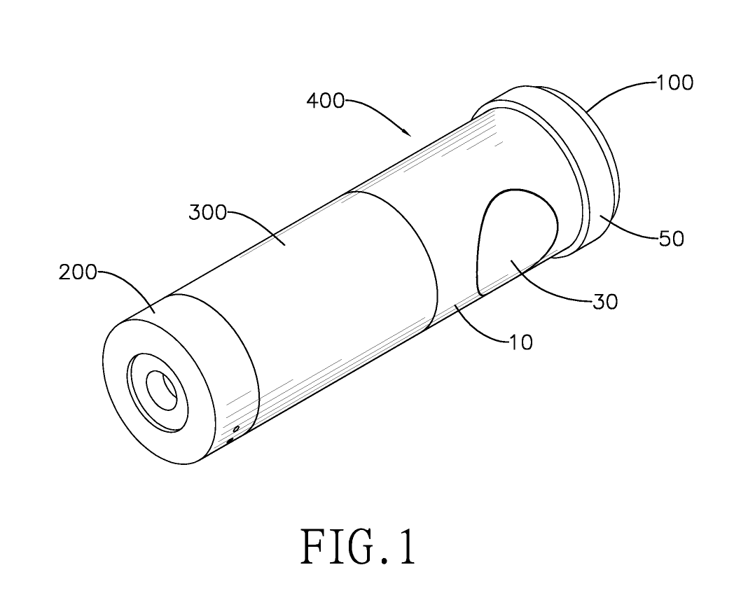

With reference to FIG. 1, a main body of an electronic cigarette in accordance with the present invention comprises a bottom cover 100, an atomizer connector 200 and a central assembly.

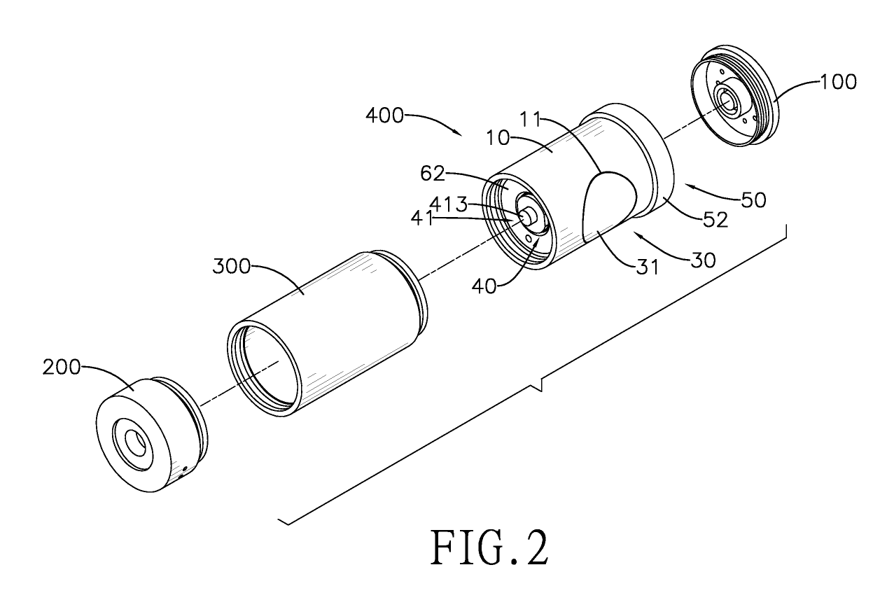

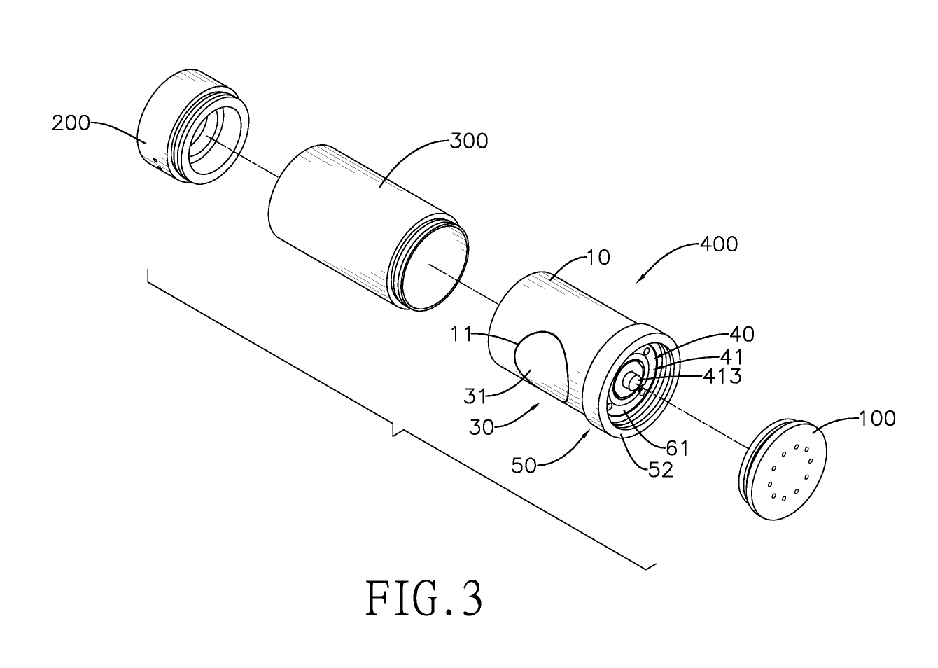

With reference to FIGS. 2 and 3, the central assembly has a first end and a second end. The first end is connected to the bottom cover 100. The second end is connected to and forms an electrical connection with the atomizer connector 200. The central assembly further has a battery sleeve 300 and a switch assembly 400. The battery sleeve 300 and the switch assembly 400 are connected to and form an electrical connection with each other. In a preferred embodiment, the battery sleeve 300 is connected to the atomizer connector 200, and the switch assembly 400 is connected to the bottom cover 100. But the connections are by no means limited to the abovementioned, and are adjustable.

With reference to FIGS. 2 to 4, the switch assembly 400 has a casing 10, a middle sleeve 20, a switch element 30, a control unit 40, a locking element 50, a locking block ring 61 and a middle block ring 62.

The casing 10 has a first end and a second end opposite to each other. The first end is connected to the bottom cover 100, and the second end is connected to the battery sleeve 300. The casing 10 is a circular tube, and further has an axis, an inner space, two axial openings and a switch hole 11. The switch hole 11 is formed transversely through a wall of the casing 10.

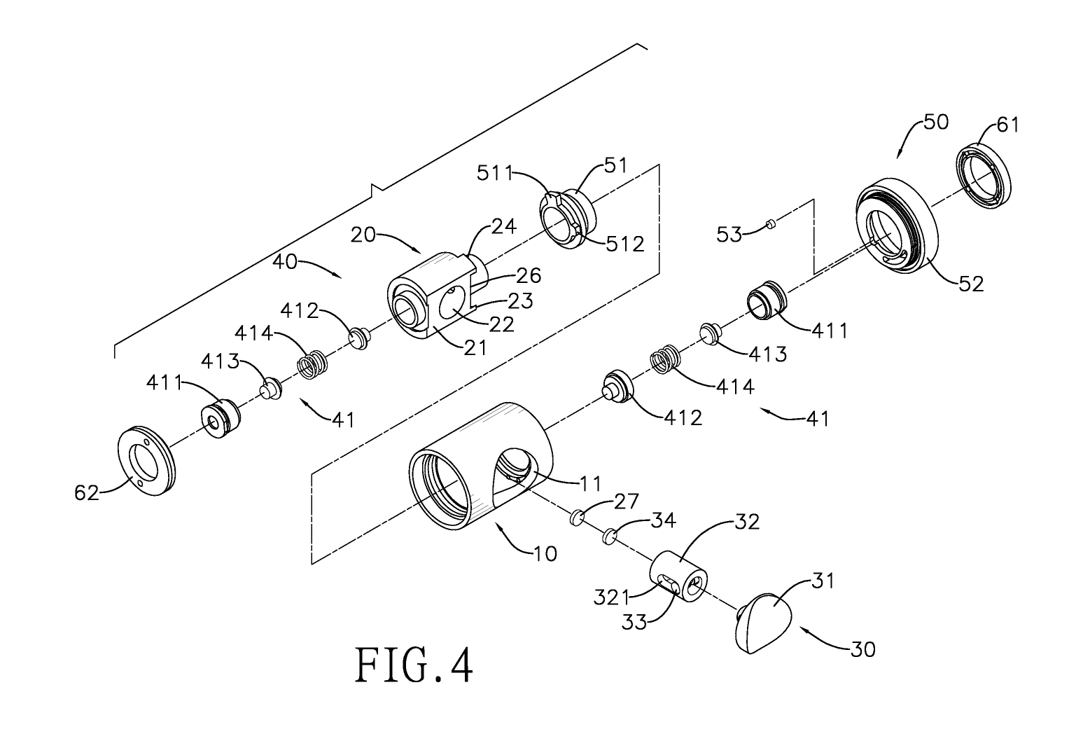

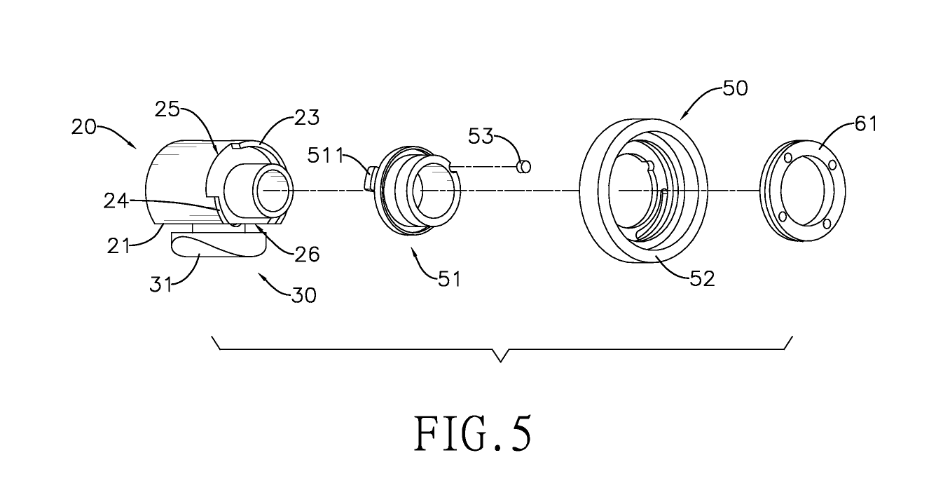

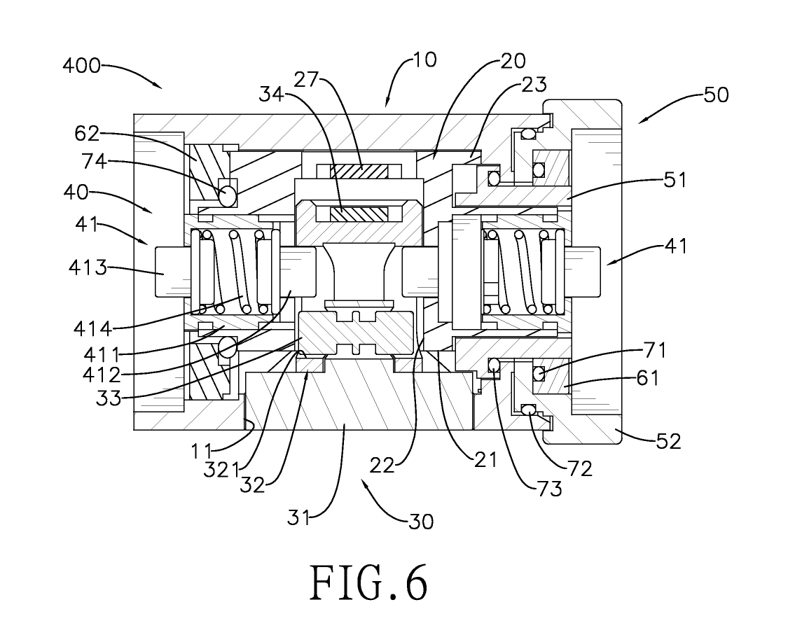

With reference to FIGS. 4 to 7, the middle sleeve 20 is mounted in the casing 10, axially abuts an inner wall of the casing 10, and has an inner space, two axial openings, an abutting surface 21, a switch hole 22, a first limit wall 23, a second limit wall 24, a first gap 25 and a second gap 26. The abutting surface 21 is formed in an outer wall of the middle sleeve 20. The switch hole 22 is formed through the abutting surface 21. The limit walls 23, 24 are formed on an axial end of the middle sleeve 20, and are annularly arranged spaced apart from each other to form the first gap 25 and the second gap 26. A first magnetic element 27 is mounted on an inner wall of the middle sleeve 20. The first magnetic element 27 and the switch hole 22 are disposed in two opposite sides of the middle sleeve 20 as shown in FIG. 6.

With reference to FIGS. 2 and 4 to 7, the switch element 30 is transversely moveably mounted in the switch hole 11 of the casing 10 and the switch hole 22 of the middle sleeve 20, and has a pressing element 31, a through element 32, an actuating element 33 and a second magnetic element 34. The pressing element 31 is mounted in the switch hole 11 of the casing 10 and the switch hole 22 of the middle sleeve 20. A position of an inner side of the pressing element 31 corresponds to a position of the abutting surface 21 of the middle sleeve 20. A shape of a transverse outer surface of the pressing element 31 corresponds to a shape of an outer wall of the casing 10 as shown in FIG. 2. When the switch element 30 is moved furthest out transversely relative to the casing 10, the transverse outer surface of the pressing element 31 aligns with the outer wall of the casing 10 as shown in FIG. 6. The through element 32 is mounted in the middle sleeve 20 and has a first end and a second end opposite to each other. The first end is connected to the pressing element 31. The through element 32 further has an inner space and two elongated holes 321. The elongated holes 321 are formed through a wall of the through element 32, and are disposed in two opposite sides of the through element 32. A lengthwise direction of each elongated hole 321 is parallel to the moving direction of the switch element 30. The actuating element 33 is mounted in the through element 32, is connected to the pressing element 31, and is an electric conductor. Two ends of the actuating element 33 are respectively mounted in the elongated holes 321 of the through element 32. The second magnetic element 34 is mounted in the second end of the through element 32 as shown in FIG. 6. A position of the second magnetic element 34 corresponds to a position of the first magnetic element 27. The second magnetic element 34 and the first magnetic element 27 repel each other.

With reference to FIGS. 2 and 4 to 6, the control unit 40 is mounted in the middle sleeve 20, is selectively actuated by the actuating element 33 of the switch element 30, and has two electrical connecting segments 41. The electrical connecting segments 41 are respectively mounted in the openings of the middle sleeve 20, and positions of the electrical connecting segment 41 respectively correspond to positions of the openings of the casing 10. Two outer axial ends of the electrical connecting segments 41 are respectively mounted in the openings of the casing 10. Two inner axial ends of the electrical connecting segments 41 are respectively mounted in the elongated holes 321 of the through element 32, and respectively and selectively abut the ends of the actuating element 33 of the switch element 30. Each electrical connecting segment 41 has a fixing sleeve 411, an inner electric conductor 412, an outer electric conductor 413 and a spring 414. The fixing sleeve 411 is mounted and screwed securely in the middle sleeve 20. The electric conductors 412, 413 are mounted in the fixing sleeve 411. The inner electric conductor 412 is mounted in the corresponding elongated hole 321 of the through element 32. The outer electric conductor is mounted in the corresponding opening of the casing 10. The spring 414 is mounted between the inner electric conductor 412 and the outer electric conductor 413, and pushes the inner electric conductor 412 and the outer electric conductor 413 away from each other.

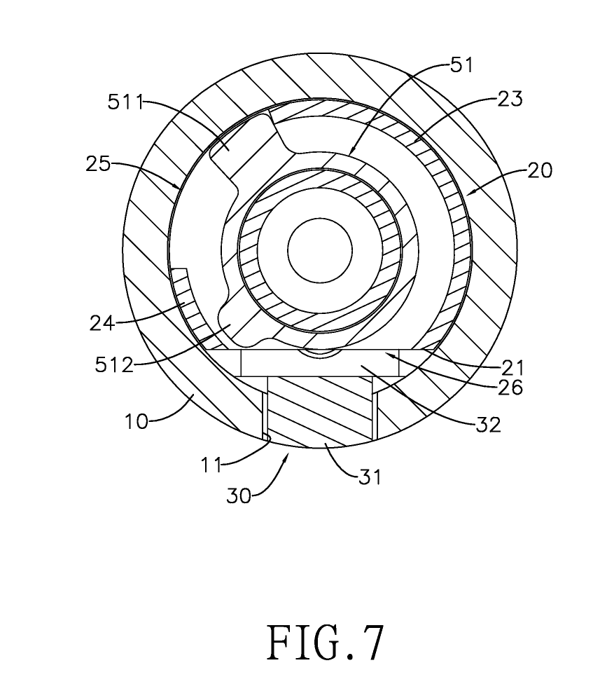

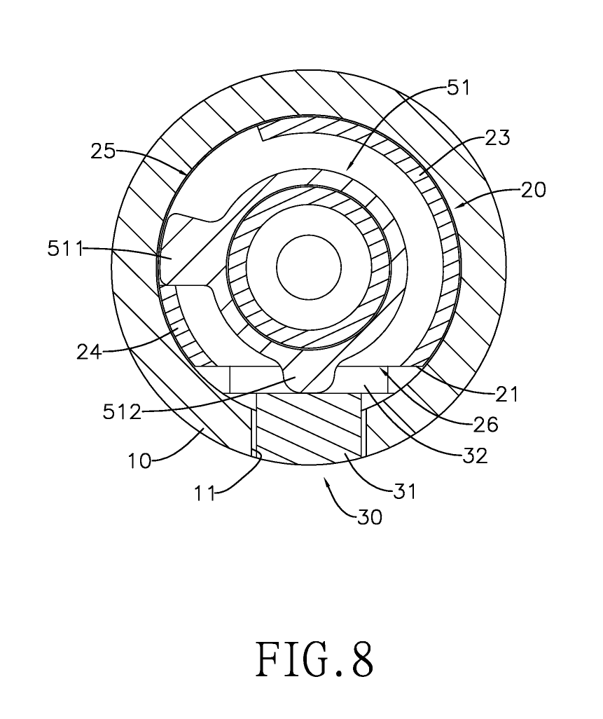

With reference to FIGS. 3 to 5, 7 and 8, the locking element 50 is disposed in the first end of the casing 10. In a preferred embodiment, the locking element 50 is mounted between the casing 10 and the bottom cover 100. But the installations are by no means limited to the abovementioned, and are adjustable. An inner axial end of the locking element 50 is mounted in the casing 10. The locking element 50 is rotatable relative to the casing 10 along the axis of the casing 10, and has an inner element 51, an outer ring 52, and a fixing element 53. The inner element 51 is mounted in the casing 10, and is mounted around the middle sleeve 20. The inner element 51 is axially clamped between the casing 10 and the middle sleeve 20, but the inner element 51 is still rotatable relative to the casing 10 and the middle sleeve 20. An outer axial end of the inner element 51 is mounted in one of the openings of the casing 10. The inner element 51 has a limit segment 511 and a stop segment 512. The limit segment 511 and the stop segment 512 are transversely formed on an inner axial end of the inner element 51. Positions of the limit segment 511 and the stop segment 512 respectively correspond to positions of the first gap 25 and the second gap 26 of the middle sleeve 20. The limit segment 511 is disposed between the first limit wall 23 and the second limit wall 24 of the middle sleeve 20, and selectively abuts the first limit wall 23 and the second limit wall 24, such that the inner element 51 is limited in the range of the rotating angle. A transverse length of the stop segment 512 is smaller than a transverse length of the limit segment 511, and the stop segment 512 does not abut the first limit wall 23 and the second limit wall 24 during the rotating of the inner element 51. When the limit segment 511 abuts the first limit wall 23, the stop segment 512 leaves the second gap 26 and is disposed inside of the second limit wall 24 as shown in FIG. 7. When the limit segment 511 abuts the second limit wall 24, the stop segment 512 is disposed in the second gap 26, protrudes transversely out of the abutting surface 21 of the middle sleeve 20, and abuts the pressing element 31 of the switch element 30 as shown in FIG. 8. Therefore, the switch element 30 cannot be pressed and moved, and thus cannot actuate and switch on the control unit 40. The outer ring 52 is mounted on the first end of the casing 10, and is mounted around the inner element 51. The fixing element 53 is mounted in the inner element 51 and the outer ring 52, and is eccentric relative to the inner element 51 and the outer ring 52, such that the fixing element 53 makes the inner element 51 rotated by the outer ring 52.

With reference to FIGS. 3 to 6, the locking block ring 61 is mounted around and screwed securely to the inner element 51 of the locking element 50, and axially inward abuts the outer ring 52, thereby axially fixing the outer ring 52 to make sure the fixing element 53 is unable to be removed.

With reference to FIGS. 2, 4 and 6, the middle block ring 62 is mounted in and screwed securely to the opening of the casing 10 and opposite to the locking element 50, and axially inward abuts the middle sleeve 20, such that the middle sleeve 20 is axially clamped between the middle block ring 62 and the inner wall of the casing 10.

With reference to FIG. 6, a gasket 71 is mounted between the locking block ring 61 and the outer ring 52. A gasket 72 is mounted between the outer ring 52 and the casing 10. A gasket 73 is mounted between the inner element 51 and the casing 10. A gasket 74 is mounted between the middle block ring 62 and the middle sleeve 20.

With reference to FIGS. 2, 3 and 9, when the main body of the electronic cigarette as described is in use, an atomizer is connected to the atomizer connector 200. A battery 500 is mounted in the battery sleeve 300, and is preferably a lithium battery. One of two ends of the lithium battery 500 abuts the atomizer connector 200, and the other end of the lithium battery 500 abuts the outer electric conductor 413 of one of the electrical connecting segments 41 of the control unit 40. With reference to FIGS. 6, 7 and 9, to switch on the main body of the electronic cigarette, the locking element 50 is rotated relative to the casing 10 until the stop segment 512 leaves the second gap 26 and is disposed inside of the second limit wall 24 as shown in FIG. 7. At this time, a user can press the pressing element 31 of the switch element 30. The pressing element 31 with the through element 32 and the actuating element 33 are transversely moved inward until the pressing element 31 abuts the abutting surface 21 of the middle sleeve 20. At this time, the second magnetic element 34 is adjacent to the first magnetic element 27. The actuating element 33 abuts the inner electric conductors 412 of the electrical connecting segments 41, and pushes outward the inner electric conductors 412. Therefore, the electrical connecting segments 41 are electrically connected to each other via the actuating element 33, thereby actuating and switching on the control unit 40. The electric power stored in the lithium battery 500 is transmitted to the atomizer connector 200, and then is transmitted to the atomizer to make the atomizer produce smoke. Once the user stops pressing the switch element 30, the second magnetic element 34 with the whole switch element 30 is transversely pushed out to the original position by magnetic force, as the second magnetic element 34 and the first magnetic element 27 repel each other. Therefore, the actuating element 33 does not touch the electrical connecting segments 41 anymore, and the electrical connecting segments 41 are not electrically connected to each other. As a result, the control unit 40 is switched off, and the atomizer does not produce smoke.

With reference to FIGS. 6, 8 and 9, to lock the locking element 50, the locking element 50 is rotated reversely relative to the casing 10 until the stop segment 512 is disposed in the second gap 26 and protrudes out of the abutting surface 21 of the middle sleeve 20 as shown in FIG. 8. At this time, the stop segment 512 abuts the switch element 30, and thus the switch element 30 cannot be pressed and moved, thereby making the locking element 50 locked.

No matter at what angle the main body of the electronic cigarette is disposed, the locking element 50 does not tend to be rotated and unlocked by its weight as the locking element 50 is not screwed to the casing 10. Therefore, the locking element 50 is effectively kept locked to prevent the electronic cigarette from being switched on accidentally.

Besides, at this time, the transverse outer surface of the pressing element 31 aligns with the outer wall of the casing 10, which means the switch element 30 does not transversely protrude out of the casing 10, thereby preventing the switch element 30 from being pressed and switched on inadvertently. The overall shape of the electronic cigarette is more aesthetically appealing as well.

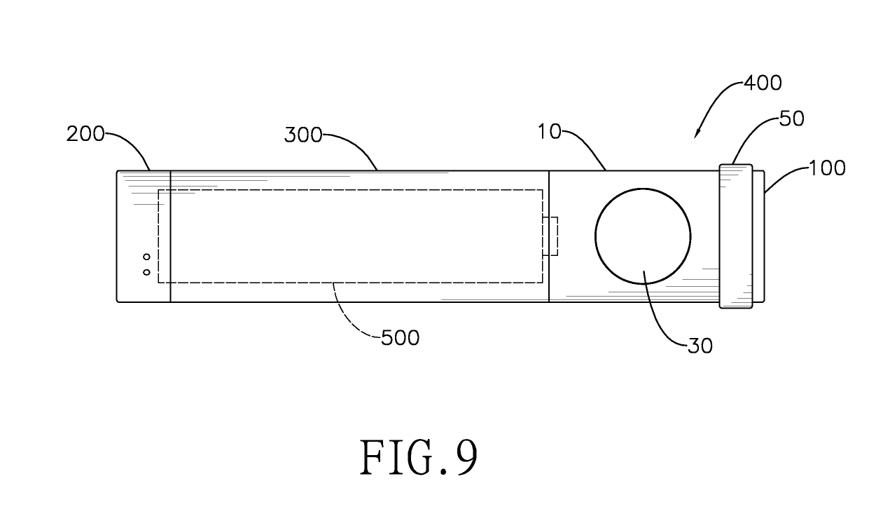

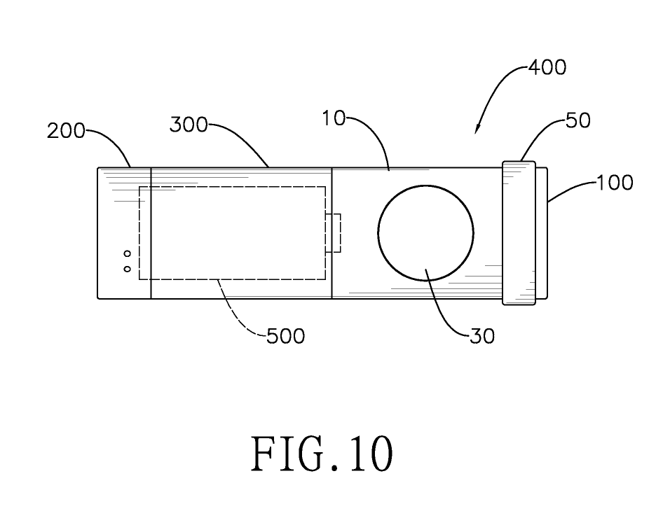

With reference to FIG. 9, the battery sleeve 300 in FIG. 9 is a long battery sleeve 300 adapted for lithium battery 500 with longer length such as 18650 lithium battery. With reference to FIG. 10, to be adapted for lithium battery 500 with short length such as 18350 lithium battery, the long battery sleeve 300 is replaced by a short battery sleeve 300.

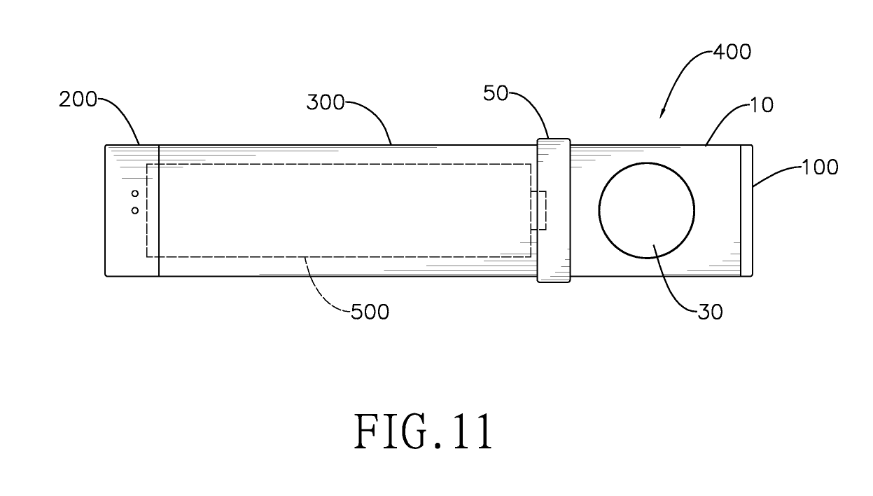

With reference to FIG. 9, the casing 10 is connected to the bottom cover 100 by the first end, which is installed with the locking element 50, such that the locking element 50 is disposed in an end of the main body of the electronic cigarette. With reference to FIG. 11, to change the position of the locking element 50, the switch assembly 400 is mounted in a reverse direction to make the casing 10 connected to the battery sleeve 300 by the first end, which is installed with locking element 50, and to make the casing 10 connected to the bottom cover 100 by the other end (second end) of the casing 10. Thus, the position of the locking element 50 is moved inward, which enables the user to operate the locking element 50 by other fingers or gestures.

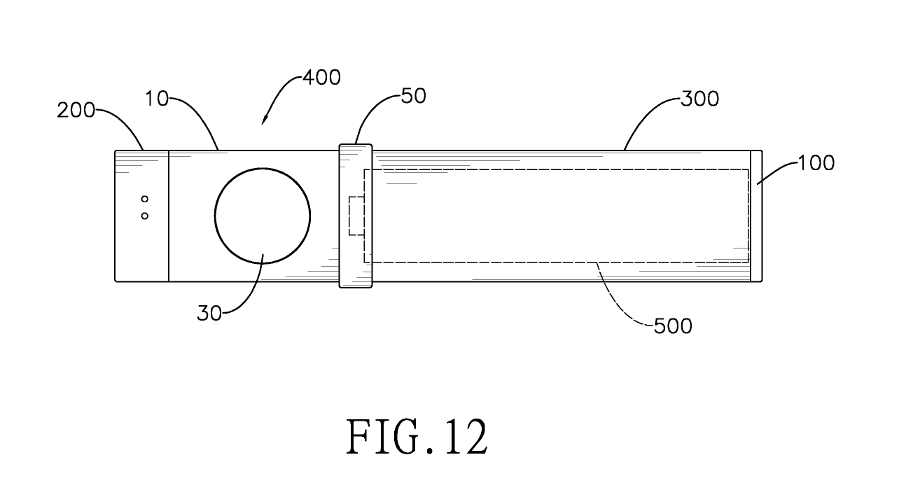

No matter in assembly of FIG. 9 or FIG. 11, the switch assembly 30 is disposed in the end adjacent to the bottom cover 100. With reference to FIG. 12, to change the position of the switch element 30, the switch assembly 400 is mounted between the atomizer connector 200 and the battery sleeve 300, and the bottom cover 100 is connected to the other side of the battery sleeve 300. Thus, the switch element 30 is disposed in the end adjacent to the atomizer connector 200, which enables the user to operate the switch element 30 by other fingers or gestures. In addition, the first end of the casing 10, which is installed with the locking element 50, can be connected to the atomizer connector 200 or the battery sleeve 300 to further adjust the position of the locking element 50. When the electronic cigarette in the assembly described above is in use, the lithium battery 500, the switch assembly 400, the battery sleeve 300 and the bottom cover 400 form a circuit, and the switch assembly 400 transmits the electric power to the atomizer connector 200 to make the atomizer produce smoke.

As shown in the above description and FIGS. 9, 11 and 12, both ends of the switch assembly 400 can be electrically connected to other objects, such that the bottom cover 100, the atomizer connector 200, the battery sleeve 300 and the switch assembly 400 can be assembled to various assemblies, thereby offering the user with various operating manners. A length of the battery sleeve 300 is equal to the length of the lithium battery 500, which means both ends of the switch assembly 400 have no recess for the lithium battery 500 to be inserted in. Therefore, the switch assembly 400 is not prolonged when both ends of the switch assembly 400 are designed to be capable of electrical connection to other objects. As a result, the electronic cigarette can keep its small volume to be conveniently carried.

In another embodiment, the casing of the switch assembly may have only one axial opening, and the control unit may have only one electrical connecting segment, which means the switch assembly can only be mounted between the bottom cover and the battery sleeve, and the switch assembly cannot be rotated to adjust the position of the locking element. However, the switch element of the switch assembly still can be effectively kept locked.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A switch assembly of a main body of an electronic cigarette comprising:
a casing having
an axis;
an inner space;
a first end;
a second end opposite to the first end of the casing;
at least one axial opening; and
a switch hole formed transversely through a wall of the casing;
a control unit mounted in the casing and having
at least one electrical connecting segment; a position of each one of the at least one electrical connecting segment corresponding to a position of one of the at least one opening of the casing;
a switch element transversely moveably mounted in the switch hole of the casing, and having
an actuating element being an electric conductor and selectively actuating the control unit; and
a locking element disposed in the first end of the casing, being rotatable relative to the casing along the axis of the casing, and having
an inner axial end mounted in the casing; and
a stop segment transversely formed on the inner axial end of the locking element and selectively abutting the switch element.

2. The switch assembly of a main body of an electronic cigarette as claimed in claim 1 further comprising a middle sleeve, wherein
the middle sleeve is mounted in the casing, and has
an inner space;
at least one axial opening;
an abutting surface formed in an outer wall of the middle sleeve;
a position of the abutting surface corresponding to a position of the switch element; and
a switch hole formed through the abutting surface;
the stop segment of the locking element selectively protrudes transversely out of the abutting surface of the middle sleeve;
the control unit is mounted in the middle sleeve, and each one of the at least one electrical connecting segment of the control unit is mounted in one of the at least one opening of the middle sleeve; and
the switch element is transversely moveably mounted in the switch hole of the middle sleeve.

3. The switch assembly of a main body of an electronic cigarette as claimed in claim 2, wherein
the middle sleeve has
two limit walls formed on an axial end of the middle sleeve, and being annularly arranged spaced apart from each other; and
the locking element has
a limit segment transversely formed on the inner axial end of the locking element, disposed between the limit walls of the middle sleeve, and selectively abutting the limit walls.

4. The switch assembly of a main body of an electronic cigarette as claimed in claim 1 further comprising a locking block ring, wherein
the locking element has
an inner element mounted in the casing, and has
an outer axial end mounted in one of the at least one opening of the casing; and
an inner axial end; the stop segment of the locking element transversely formed on the inner axial end of the inner element;
an outer ring mounted on the first end of the casing and mounted around the inner element; and
a fixing element mounted in the inner element and the outer ring, and being eccentric relative to the inner element and the outer ring; and
the locking block ring is mounted around the inner element, and axially inward abuts the outer ring.

5. The switch assembly of a main body of an electronic cigarette as claimed in claim 1, wherein a transverse outer surface of the switch element aligns with an outer wall of the casing when the switch element is moved furthest out transversely relative to the casing.

6. The switch assembly of a main body of an electronic cigarette as claimed in claim 1, wherein the casing has two axial openings, and the control unit has two electrical connecting segments.

7. The switch assembly of a main body of an electronic cigarette as claimed in claim 6, wherein
the switch element has
a pressing element mounted in the switch hole of the casing; and
a through element mounted in the casing, and having
an inner space;
a first end connected to the pressing element;
a second end opposite to the first end of the through element; and
two elongated holes formed through a wall of the through element and disposed in two opposite sides of the through element; a lengthwise direction of each elongated hole is parallel to the moving direction of the switch element;
two inner axial ends of the electrical connecting segments are respectively mounted in the elongated holes; and
the actuating element is mounted in the through element and is connected to the pressing element; two ends of the actuating element are respectively mounted in the elongated holes of the through element, and respectively and selectively abut the inner axial ends of the electrical connecting segments.

8. The switch assembly of a main body of an electronic cigarette as claimed in claim 7, wherein each electrical connecting segment has
a fixing sleeve mounted securely in the casing;
an inner electric conductor mounted in the fixing sleeve, and mounted in one of the elongated holes of the through element;
an outer electric conductor mounted in the fixing sleeve, and mounted in one of the openings of the casing; and
a spring mounted between the inner electric conductor and the outer electric conductor, and pushing the inner electric conductor and the outer electric conductor away from each other.

9. The switch assembly of a main body of an electronic cigarette as claimed in claim 7, wherein
the casing further has
a first magnetic element; and
the switch element further has
a second magnetic element mounted in the second end of the through element; a position of the second magnetic element corresponding to a position of the first magnetic element; the second magnetic element and the first magnetic element repelling each other.

10. A main body of an electronic cigarette comprising:
a bottom cover;
an atomizer connector; and
a central assembly having
a first end connected to the bottom cover;
a second end connected to and forming an electrical connection with the atomizer connector;
a battery sleeve; and
the switch assembly as claimed in claim 1, connected to and forming an electrical connection with the battery sleeve.

11. A main body of an electronic cigarette comprising:
a bottom cover;
an atomizer connector; and
a central assembly having
a first end connected to the bottom cover;
a second end connected to and forming an electrical connection with the atomizer connector;
a battery sleeve; and
the switch assembly as claimed in claim 6, connected to and forming an electrical connection with the battery sleeve.

12. The main body of an electronic cigarette as claimed in claim 11, wherein in the central assembly, the battery sleeve is connected to the atomizer connector, and the switch assembly is connected to the bottom cover.

13. The main body of an electronic cigarette as claimed in claim 12, wherein in the switch assembly of the central assembly, the first end of the casing is connected to the bottom cover, and the second end of the casing is connected to the battery sleeve.

14. The main body of an electronic cigarette as claimed in claim 12, wherein in the switch assembly of the central assembly, the first end of the casing is connected to the battery sleeve, and the second end of the casing is connected to the bottom cover.

15. The main body of an electronic cigarette as claimed in claim 11, wherein in the central assembly, the battery sleeve is connected to the bottom cover, and the switch assembly is connected to the atomizer connector.
